(19) United States
(12) Patent Application Publication
(10) Pub. No.: US 2006/0236045 A1
(43) Pub. Date: Oct. 19, 2006

(54) Apparatus for deinterleaving interleaved data using direct memory access

(75) Inventor: Kenneth J. Keyes JR., Tinton Falls, NJ (US)

Correspondence Address: Jeffrey T. Klayman;Bromberg & Sunstein LLP, 125 Summer Street, Boston, MA, 02110-1618, US

(73) Assignee: Analog Devices, Inc.

(21) Appl. No.: 11/104,738

(22) Filed: Apr. 13, 2005

(51) Int. Cl. G06F 13/28

(52) U.S. Cl. 711/157

(57) ABSTRACT

Deinterleaving is performed using a “smart” direct memory access (DMA) function. The deinterleaver, which may be a modified DMA controller, can be programmed with a step size so that the deinterleaver reads every Nth byte from the memory. The deinterleaver automatically increments the source memory address by the step size to read successive bytes of a codeword. The deinterleaved data can be written to the same memory, to a different memory, or to some other device.

### FIELD OF THE INVENTION

The present invention relates generally to data processing, and, more particularly, to deinterleaving using a “smart” direct memory access technique.

### BACKGROUND OF THE INVENTION

Data communications are typically encoded in order to improve performance. Different types of coding schemes, such as convolutional codes, block codes, and interleaving, can be used.

A convolutional interleaver spreads data from one codeword in a transmitted stream across a number of codewords. This enhances the likelihood of the correction of a large burst error during transmission, since the error will be fragmented over multiple codewords.

A convolutional interleaver is often used as part of a concatenated coding scheme that includes block coding (e.g., Reed-Solomon), convolutional interleaving, and a convolutional coding. FIG. 1 shows an exemplary transmitter that employs a concatenated code including a Reed-Solomon block coder, a convolutional interleaver, and a convolutional coder. A receiver (not shown) would typically include corresponding decoders to decode the respective coding operations.

In the transmitter shown in FIG. 1, the Reed-Solomon block coder forms codewords (blocks) from input data by appending a number of check bytes to a number of data bytes. The check bytes allow the receiver, and, more particularly, a Reed-Solomon decoder in the receiver, to recover the originally transmitted data even if the codeword is received with a certain number of errors. The codewords are not intrinsically tied to baseband frames and frame boundaries. Therefore, it is possible for a codeword to span over several baseband frames or for a single baseband frame to contain multiple codewords.

Performance is improved by convolutionally interleaving the codewords generated by the Reed-Solomon block coder. Rather than transmitting entire successive codewords, the convolutional interleaver interleaves portions of multiple codewords. The spreading length is defined by the equation (N−1)*D+1, wherein N is the codeword length and D is the interleave depth. FIG. 2 shows an exemplary interleaved transmitted data stream with a codeword length (N) of seven and an interleave depth (D) of two. The top data stream in FIG. 2 represents the transmit data stream without interleaving the codwords. The figure shows five codewords being transmitted, namely codewords cw_a, cw_b, cw_c, cw_d, and cw_e. One codeword byte is sent every transmit interval. Following the last byte of a codeword sent is the first byte of the next codeword. Below the non-interleaved data stream representation is a representation of the spreading of the codewords using an interleave depth of two. Conceptually, a space is inserted between each codeword byte, spreading the seven-byte codeword over the length of two codewords (13 bytes, in this example). The interleaver fills in the spaces between codeword bytes with bytes from the previous codeword. The first byte of every codeword remains in the same location as the non-interleaved data stream, as represented in the bottom data stream shown in FIG. 2.

In the receiver, the received, interleaved data stream is deinterleaved so that entire codewords are fed into the Reed-Solomon decoder. This is typically done by storing the received data stream in a memory and rearranging the interleaved bytes into blocks that can then be fed into the Reed-Solomon block decoder. Deinterleaving can be done in hardware or software. Software-based deinterleaving can consume significant amounts of the processing power of a microprocessor or digital signal processor. The decision to use hardware or software based deinterleaving is generally a trade-off between processing power consumed by software and the space and power consumed by hardware.

### SUMMARY OF THE INVENTION

In embodiments of the present invention, deinterleaving is performed using a “smart” direct memory access (DMA) function. A “smart” DMA controller (referred to hereinafter as the SDMA controller), which may be a modified DMA controller, can be programmed with a step size so that the SDMA controller reads every Nth byte from the memory. The SDMA controller automatically increments the source memory address by the step size to read successive bytes of a codeword. The deinterleaved data can be written to the same memory, to a different memory, or to some other device. Generally speaking, embodiments of the present invention provide substantially hardware-based deinterleaving solutions with low processor usage.

In accordance with one aspect of the invention there is provided apparatus for deinterleaving interleaved data including at least one memory interface for coupling to at least one memory and a controller in communication with the at least one memory interface for directly accessing the at least one memory for reading successive interleaved data bytes stored therein based on a predetermined step size greater than one.

The interleaved data may be convolutionally interleaved data, and may include codewords generated by a coding device. Deinterleaved data may be written to the at least one memory, which may be a single memory partitioned into separate source (interleaved) and destination (deinterleaved) sections or may be separate memories accessed by the controller through a single memory interface or through separate memory interfaces. Deinterleaving may involve concatenating multiple interleaved bytes and writing the concatenated bytes to the destination memory. The controller may include a holding register for concatenating the interleaved bytes. The step size may be fixed or programmable.

In accordance with another aspect of the invention there is provided apparatus for deinterleaving interleaved data including at least one memory for storing interleaved data and a deinterleaver in communication with the at least one memory for directly accessing the at least one memory for reading successive interleaved data bytes stored therein based on a predetermined step size greater than one.

The interleaved data may be convolutionally interleaved data, and may include codewords generated by a coding device. Deinterleaved data may be written to the at least one memory, which may be a single memory partitioned into separate source (interleaved) and destination (deinterleaved) sections or may be separate memories accessed by the controller through a single memory interface or through separate memory interfaces. Deinterleaving may involve concatenating multiple interleaved bytes and writing the concatenated bytes to the destination memory. The deinterleaver may include a holding register for concatenating the interleaved bytes. The step size may be fixed or programmable. The apparatus may further include a receiver for coupling to a communication medium and storing the interleaved data in the at least one memory. The apparatus may include a decoder for decoding the deinterleaved data stored in the at least one memory.

In accordance with another aspect of the invention there is provided apparatus for deinterleaving interleaved data including at least one memory for storing interleaved data and direct memory access means for deinterleaving the interleaved data based on a predetermined step size greater than one.

### BRIEF DESCRIPTION OF THE DRAWINGS

The foregoing and advantages of the invention will be appreciated more fully from the following further description thereof with reference to the accompanying drawings wherein:

FIG. 1 shows an exemplary communication device that generates a convolutionally interleaved data stream, as known in the art;

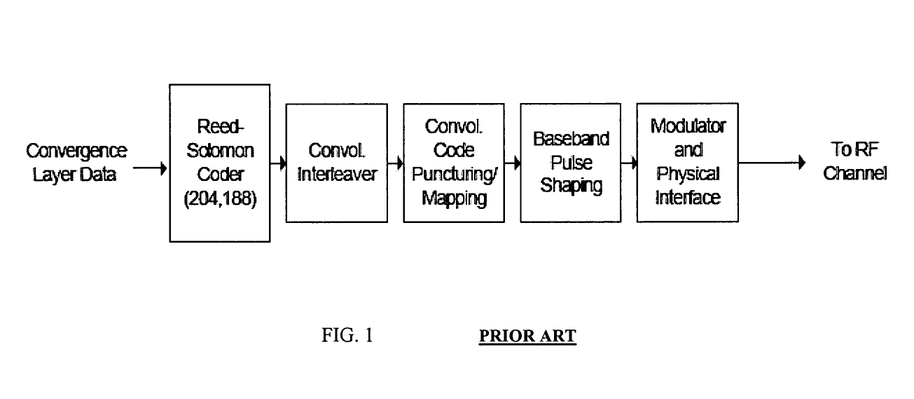

FIG. 2 shows an exemplary interleaved transmitted data stream with a codeword length (N) of seven and an interleave depth (D) of two, as known in the art;

FIG. 3 shows the definition of descriptors for controlling “smart” direct memory access functions, in accordance with an exemplary embodiment of the present invention;

FIG. 4 shows the organization of the received data stream in the receiver both before and after deinterleaving, in accordance with an embodiment of the present invention;

FIG. 5 shows a representation of the 32-bit holding register in accordance with an embodiment of the present invention;

FIG. 6 is a conceptual block diagram representing the relevant components of an exemplary communication device, such as a DSL modem, in accordance with an embodiment of the present invention;

FIG. 7 is a conceptual block diagram representing a deinterleaving system in accordance with an embodiment of the present invention; and

FIG. 8 is a conceptual block diagram representing a deinterleaving system having a source (interleaved) memory and a separate destination (deinterleaved) memory in communication with a deinterleaver over a single data bus, in accordance with an embodiment of the present invention.

### DETAILED DESCRIPTION OF A PREFERRED EMBODIMENT

In embodiments of the present invention, deinterleaving is performed using a “smart” direct memory access (DMA) function. As known in the art, DMA is a hardware-based mechanism for transferring data to and/or from memory. Generally speaking, a DMA controller is programmed with a source memory address, a destination memory address, and a transfer size, and the DMA controller automatically reads data starting at the source memory address and writes it to the destination memory address. The DMA controller can generally be programmed with other parameters, such as a “burst” size defining the maximum amount of time the DMA controller can have exclusive access to the data bus.

In accordance with embodiments of the present invention, the “smart” DMA controller (referred to hereinafter as the SDMA controller), which may be a modified DMA controller, can be programmed with a step size so that the SDMA controller reads every Nth byte from the memory. In a preferred embodiment, the step size is programmable from one to 64 bytes. The SDMA controller automatically increments the source memory address by the step size to read successive bytes of a codeword. The data can be written to another memory (or portion of the same memory), directly to the Reed-Solomon decoder, or to some other appropriate addressable entity.

In an exemplary embodiment of the present invention, the received, interleaved data stream is stored in a DSP data memory. The SDMA controller performs memory-to-memory transfers from the DSP data memory to an external memory that acts as the input memory for the Reed-Solomon decoder. The SDMA controller provides intelligent memory addressing features that can perform the deinterleaver function as part of the DMA transfer cycle. A section of the DSP memory is partitioned to be the deinterleaver buffer for storing the interleaved codewords. Among other things, this enables the deinterleaver buffer size to be dynamically allocated to the size needed, with the remainder of the DSP data memory available for other DSP operations. The DSP configures and schedules all DMA and deinterleaving operations of the SDMA controller.

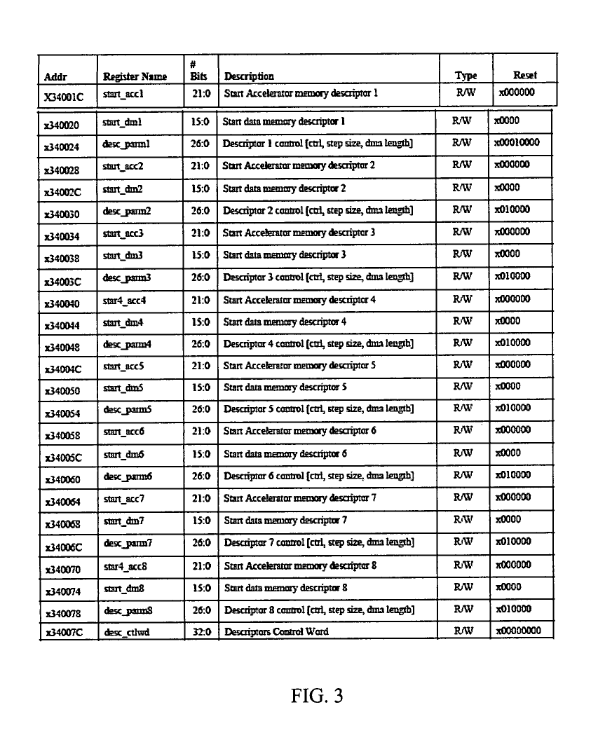

In a preferred embodiment, the DSP data memory and the destination memory are 32-bit wide memories. The data path is preferably pipelined so that memory accesses occur every clock cycle. In an exemplary embodiment, there are eight descriptors for controlling SDMA operations, as shown in FIG. 3. These descriptors allow up to eight SDMA transfers to be pre-programmed before issuing a transfer command. A descriptor defines the start address for DSP data memory, the start address for hardware accelerator memory, the DMA length, the address mode, and a control word to enable or disable each descriptor. For SDMA transfers, the DMA length indicates the number of bytes to be transferred during the DMA cycle (for normal DMA transfers, the DMA length preferably indicates the number of 32-bit words to be transferred during the DMA cycle).

Following the programming of the descriptor, a transfer command is used to start the SDMA transfers. Once initiated, the SDMA controller preferably completes all enabled descriptors without interruption, as it preferably has priority access to both the DSP and hardware accelerator memories. When the transfer associated with the last descriptor completes, the SDMA controller generates a “dma_done” flag to signal to the DSP that the SDMA transfers have completed.

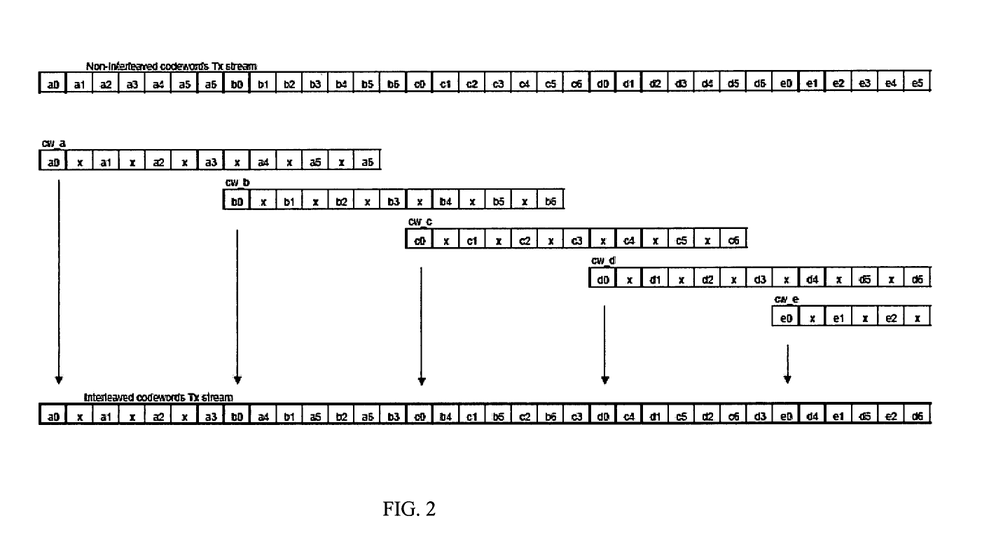

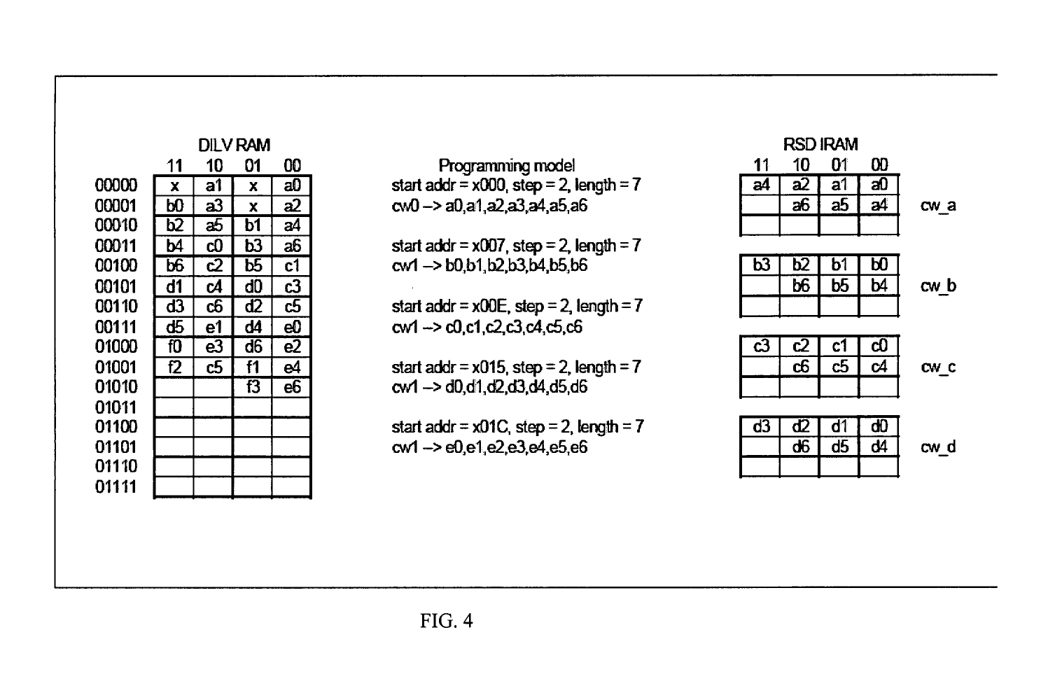

With reference to the example shown in FIG. 2, FIG. 4 shows the organization of the received data stream in the receiver both before and after deinterleaving, in accordance with an embodiment of the present invention. The left side of FIG. 4 shows the organization of the interleaved data stream in the DSP data memory. It is clear to see how the interleaved codeword bytes are dispersed two bytes apart from one another. Codeword bytes are deinterleaved one codeword at a time. For this example, the memory address needs to be set to the starting address in memory and then incremented by two to the next sequential codeword byte. The middle of FIG. 4 shows an exemplary program model for deinterleaving the five codewords, in accordance with an embodiment of the present invention. The right side of FIG. 4 shows the codeword organization in the destination memory after deinterleaving, in accordance with an embodiment of the present invention. In this example, the first codeword byte starts in the lowest address location and is written from least significant byte to most significant byte.

In a preferred embodiment, the DSP data memory is a 32-bit wide memory with byte-write capability, and the destination memory is a 32-bit wide memory that does not have byte write capability. A byte-write operation involves writing only one byte of a 32-bit wide memory address location. The two least significant address bits are used to specify which byte of the 32-bit word gets written, while the upper address bits specify the memory address location.

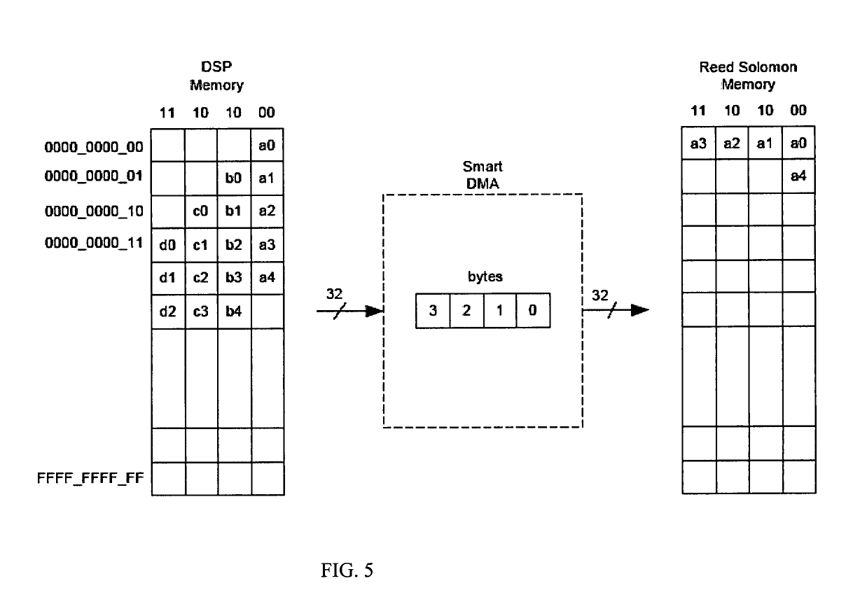

In such an embodiment, the 32-bit wide DSP data memory must be read on a byte boundary, while the destination memory must be written on a 32-bit word boundary. Therefore, the SDMA controller reads four codeword bytes from the DSP data memory and concatenates the bytes into a 32-bit word that is written to the destination memory. The SDMA controller typically includes a 32-bit holding register to enable this concatenation operation. FIG. 5 shows a representation of the 32-bit holding register in accordance with an embodiment of the present invention. When codeword lengths are not divisible by four, the 32-bit holding register is automatically transferred to the destination memory when the DMA length is realized, except in the cases of multi-frame codeword operation, as described below.

In multi-frame operation, a codeword spans over two or more baseband frames (e.g., the transmitter separated the codeword bytes into contiguous baseband frames). The codeword byte ordering in the destination memory generally needs to be contiguous for future operations, such as Reed-Solomon coding, to work correctly. Therefore, different SDMA descriptors that do not execute contiguously, or even in the same initiated DMA cycle, control the 32-bit holding register to continue concatenating codeword bytes from the deinterleaver buffer and then write to the destination memory. New codeword bytes are appended to existing codeword bytes or overwrite existing codeword bytes as needed. For example, if the holding register contains two codeword bytes at the end of a frame, the SDMA controller will append the first two codeword bytes of the following frame to the holding register before transferring the contents of the holding register to the destination memory.

In a preferred embodiment, the descriptors are used to configure the holding register operation. At the start of a new codeword transfer, the holding register is overwritten with the bytes from the deinterleaver buffer. This places the first codeword byte in the least significant byte location. For the second part of codeword bytes of the same multi-frame codeword (and subsequent parts, if present), the holding register is configured for append operation. This places the first byte of the second or subsequent part of the codeword next to the previous codeword byte (from the previous transfer) in the holding register.

In a preferred embodiment, an SDMA controller is used in a digital subscriber line (DSL) modem. DSL modems typically use convolutional interleaving during steady state operation, although DSL modems typically do not use convolutional interleaving during modem “training.” The training period generally requires more DSP data memory resources than the steady state. Therefore, in a preferred embodiment, a section of the DSP memory is used as additional data memory during training and as the deinterleaver buffer during the steady state. This scheme provides additional data memory during training while allowing the DSP memory to be shared during the steady state.

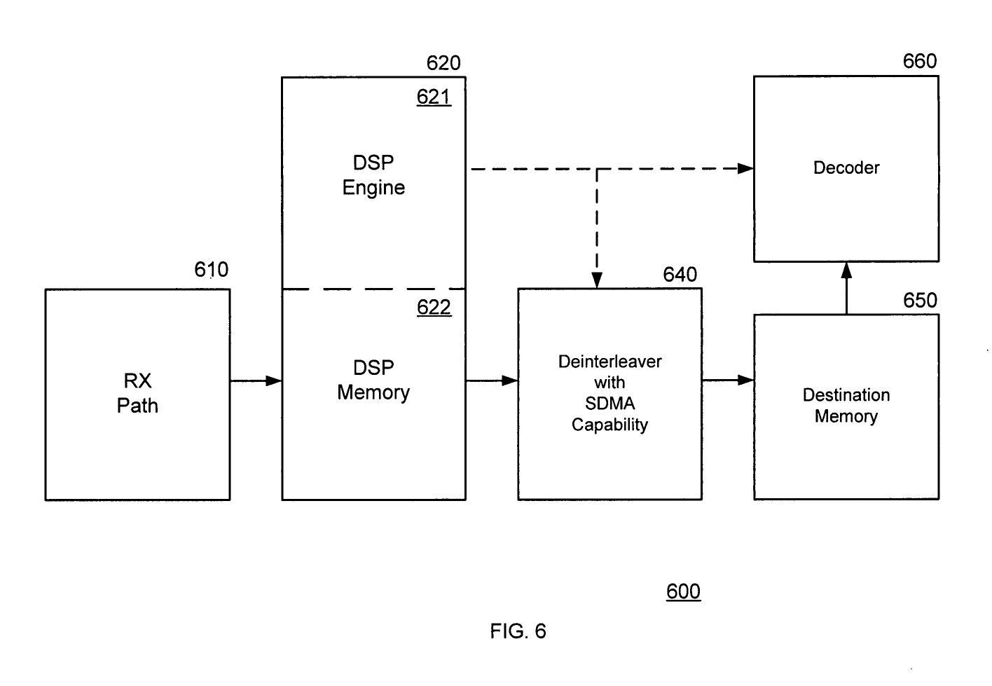

FIG. 6 is a conceptual block diagram representing the relevant components of an exemplary communication device 600, such as a DSL modem, in accordance with an embodiment of the present invention. Among other things, the communication device includes a receive (Rx) path 610, a DSP 620, a deinterleaver with SDMA capability 640, a destination memory 650, and a Reed-Solomon decoder 660. The DSP 620 includes a suitably programmed DSP engine 621 and an on-chip DSP memory 622. The Rx path 610 demodulates received signals. The demodulated signals are decoded (which may be done in whole or in part by the DSP engine 621), and interleaved data is stored in the DSP memory 622. The DSP engine 621 sets up appropriate descriptors for the deinterleaver 640, which in turn reads interleaved data from the DSP memory 622 and writes deinterleaved data into the destination memory 650. The deinterleaver 640 may include separate memory interfaces for directly accessing the DSP memory 622 and the destination memory 650. Alternatively, the DSP memory 622 and the destination memory 650 may be directly accessed by the deinterleaver 640 through a single memory interface, for example, if both the DSP memory 622 and the destination memory 650 are coupled or otherwise accessible to the deinterleaver 640 over a single data bus. The Reed-Solomon decoder 660 reads deinterleaved data from the destination memory 650 and decodes the deinterleaved data to recover the originally transmitted data.

It should be noted that the present invention is not limited to data communications nor to deinterleaving in the context of concatenated codes or block codes. Rather, an SDMA controller can be made to deinterleave virtually any type of interleaved data.

Furthermore, it should be noted that the present invention is not limited to reading interleaved data from one memory and writing deinterleaved data to a different memory. Rather, an SDMA controller can be made to read interleaved data from a memory and write deinterleaved data back to the same memory.

Thus, the present invention can be embodied as apparatus that reads successive interleaved data bytes from a source memory or other device based on a predetermined step size. The destination memory/device can be the same as the source memory/device or can be a different memory/device. The apparatus uses the predetermined step size to read every Nth byte from the source memory/device and output the bytes contiguously to the destination memory/device. The predetermined step size can be fixed for a particular implementation or can be programmable or otherwise determined dynamically. The apparatus may write deinterleaved data to a destination memory or other device.

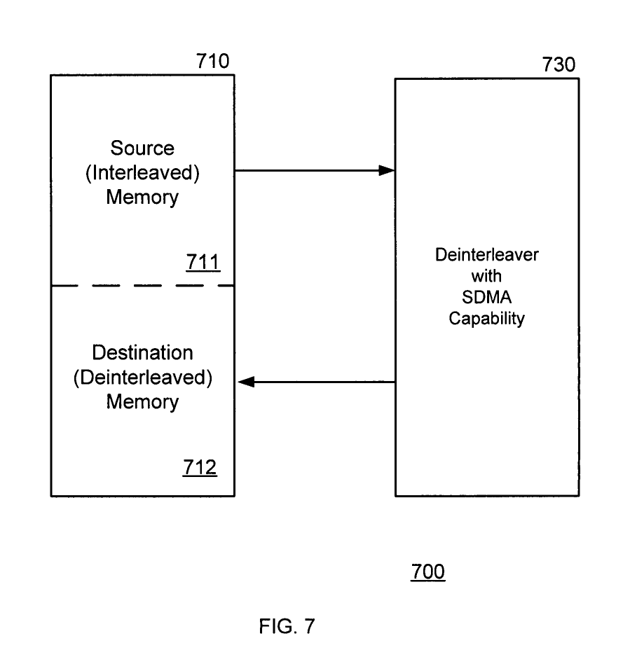

FIG. 7 is a conceptual block diagram representing a deinterleaving system 700 in accordance with an embodiment of the present invention. Among other things, the system includes at least one memory 710 and a deinterleaver 730 having SDMA capability as described herein. The at least one memory 710 includes a source memory 711 in which interleaved data is stored and a destination memory 712 to which deinterleaved data is written. The at least one memory 710 can include a single memory that is logically partitioned into a source (interleaved) memory section 711 and a destination (deinterleaved) memory section 712 or can include separate source and destination memories or even a dual-port memory in which interleaved data is read through one port and deinterleaved data is written through the other port. The deinterleaver 730 includes at least one memory interface for accessing the source memory 711 and the destination memory 712. The deinterleaver 730 reads every Nth byte of the interleaved data from the source memory 711 using direct memory access according to a predetermined step size and writes the bytes contiguously to the destination memory 712 using direct memory access.

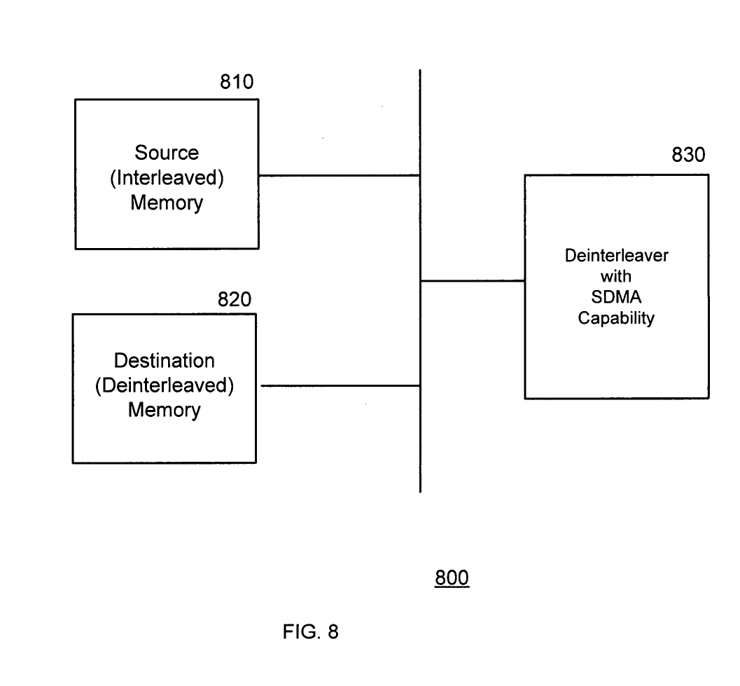

FIG. 8 is a conceptual block diagram representing a deinterleaving system 800 having a source (interleaved) memory 810 and a separate destination (deinterleaved) memory 820 in communication with a deinterleaver 840 over a single data bus 840, in accordance with an embodiment of the present invention.

As discussed above, in typical embodiments of the present invention, the deinterleaver with SDMA capability writes the deinterleaved data to a destination memory or device. It should be noted, however, that the deinterleaver is not required to write the deinterleaved data to a memory or other device. Rather, the deinterleaved data could be further stored and/or processed directly by the deinterleaver or some other device without writing the deinterleaved data to an intermediate memory.

The present invention may be embodied in many different forms, including, but in no way limited to, programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL). In an exemplary embodiment, the SDMA controller is designed using Verilog HDL.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The present invention may be embodied in other specific forms without departing from the true scope of the invention. The described embodiments are to be considered in all respects only as illustrative and not restrictive.

What is claimed is:

1. Apparatus for deinterleaving interleaved data, the apparatus comprising:
at least one memory interface for coupling to at least one memory; and
a controller in communication with the at least one memory interface for directly accessing the at least one memory for reading successive interleaved data bytes stored therein based on a predetermined step size greater than one.

2. Apparatus according to claim 1, wherein the interleaved data is convolutionally interleaved data.

3. Apparatus according to claim 1, wherein the interleaved data includes codewords generated by a coding device.

4. Apparatus according to claim 1, further comprising:
writing deinterleaved data to the at least one memory.

5. Apparatus according to claim 4, wherein the at least one memory interface comprises:
a source memory interface for coupling to a source memory from which the controller reads the interleaved data; and
a separate destination memory interface for coupling to a separate destination memory to which the controller writes the deinterleaved data.

6. Apparatus according to claim 4, wherein the at least one memory comprises a single memory logically partitioned into a source memory partition from which the controller reads the interleaved data and a destination memory partition to which the controller writes the deinterleaved data, and wherein the at least one memory interface comprises a single memory interface for directly accessing the single memory.

7. Apparatus according to claim 4, wherein the at least one memory comprises a source memory from which the controller reads the interleaved data and a separate destination memory to which the controller writes the deinterleaved data, and wherein the at least one memory interface comprises a single memory interface for directly accessing the separate source and destination memories.

8. Apparatus according to claim 4, wherein writing deinterleaved data to the at least one memory comprises:
concatenating a plurality of successive interleaved data bytes; and
writing the concatenated bytes to the at least one memory.

9. Apparatus according to claim 8, wherein the controller includes a holding register for concatenating the plurality of successive interleaved data bytes.

10. Apparatus according to claim 1, wherein the step size is programmable.

11. Apparatus for deinterleaving interleaved data, the apparatus comprising:
at least one memory for storing interleaved data; and
a deinterleaver in communication with the at least one memory for directly accessing the at least one memory for reading successive interleaved data bytes stored therein based on a predetermined step size greater than one.

12. Apparatus according to claim 11, wherein the interleaved data is convolutionally interleaved data.

13. Apparatus according to claim 11, wherein the interleaved data includes codewords generated by a coding device.

14. Apparatus according to claim 11, wherein the deinterleaver further writes deinterleaved data to the at least one memory.

15. Apparatus according to claim 14, wherein the at least one memory interface comprises:
a source memory from which the deinterleaver reads the interleaved data; and
a separate destination memory to which the deinterleaver writes the deinterleaved data.

16. Apparatus according to claim 14, wherein the at least one memory comprises a single memory logically partitioned into a source memory partition from which the controller reads the interleaved data and a destination memory partition to which the controller writes the deinterleaved data.

17. Apparatus according to claim 14, wherein the deinterleaver is operably coupled to concatenate a plurality of successive interleaved data bytes and write the concatenated bytes to the at least one memory.

18. Apparatus according to claim 17, wherein the deinterleavers includes a holding register for concatenating the plurality of successive interleaved data bytes.

19. Apparatus according to claim 11, wherein the step size is programmable.

20. Apparatus according to claim 11, further comprising:
a receiver for coupling to a communication medium, the receiver storing the interleaved data in the at least one memory.

21. Apparatus according to claim 14, further comprising:
a decoder for decoding the deinterleaved data stored in the at least one memory.

22. Apparatus for deinterleaving interleaved data, the apparatus comprising:
at least one memory for storing interleaved data; and
direct memory access means for deinterleaving the interleaved data based on a predetermined step size greater than one.
